(19) United States
(12) Patent Application Publication
(10) Pub. No.: US 2009/0132177 A1
(43) Pub. Date: May 21, 2009

(54) Detection Arrangements and Systems

(75) Inventor: Paul Douglas Arnold, Bromham (GB)

Correspondence Address: FOLEY AND LARDNER LLP;SUITE 500, 3000 K STREET NW, WASHINGTON, DC, 20007, US

(73) Assignee: Smiths Detection-Watford Limited

(21) Appl. No.: 12/227,703

(22) PCT Filed: Jun. 20, 2007
(86) PCT No.: PCT/GB2007/002300

§ 371 Date: Nov. 25, 2008

(30) Foreign Application Priority Data
Jun. 21, 2006 (GB) 0612271.7

(51) Int. Cl. G01N 31/00; G06F 15/00

(52) U.S. Cl. 702/24; 702/188

(57) ABSTRACT

A detection system has several conventional computers (1, 2, 3) with one or two IMS detectors (20, 21) mounted in their PCI slots (18, 19). The sieve packs (26, 27) of the detectors (20, 21) may be mounted outside the detector casing itself and within the computer housing (10) so that they can be larger, to extend time between replacement. Power supply and a part at least of the processing of the detectors (20, 21) is provided by the computers (1, 2, 3). The computers (1, 2, 3) are connected in a network system so that an indication of detection of hazardous substances can be provided at a remote location.

This invention relates to detection arrangements.

Various technologies are available today that can effectively detect and identify a wide range of hazardous materials in air. One such technology involves ion mobility spectrometers (IMS), which can provide a rapid and reliable indication of the presence of a hazardous material in relatively low concentration. The problem, however, is that the detectors can only provide a localised warning of the presence of such hazardous materials in the immediate vicinity of the detector or in locations downwind of a source of such materials. In situations where there might be a particularly high risk of the presence of hazardous materials, such as, for example, in the vicinity of a chemical plant, an airport, a military base or government establishments, it would be desirable to provide multiple detectors at different locations. The problem with this, however, is that reliable detectors are relatively expensive so providing a large number of them is not usually possible. Also, the sieve pack within IMS apparatus has a relatively short life so it requires frequent routine replacement, which can be inconvenient where a large number of apparatus are at different locations.

It is an object of the present invention to provide alternative detection arrangements.

According to one aspect of the present invention there is provided a detection arrangement, characterised in that the arrangement includes a computer, chemical detector apparatus and an electrical interconnection of the detector apparatus with the computer, and that the computer is arranged to provide a source of electrical power for the detector apparatus and is arranged to receive an output from the detector apparatus.

The detector apparatus is preferably located within the housing of the computer. The computer may include two separate detector apparatus responsive to different chemicals, such as by having different doping. The detector apparatus preferably includes an ion mobility spectrometer. The or each ion mobility spectrometer may include a sieve pack located outside the spectrometer but within the housing of the computer with which the spectrometer is associated. The or each detector apparatus is preferably located in a PCI slot of the computer. The or each computer preferably provides at least a part of the processing for the or each detector apparatus. Detection of a substance is preferably indicated by an output indication by the computer associated with the detector apparatus, such as an audible indication. The arrangement may include a meteorological information input. The or each computer may includes a position input.

According to another aspect of the present invention there is provided a system including a plurality of detection arrangements according to the above one aspect of the present invention. Preferably the computers of the detection arrangements are interconnected with one another, at least one computer in the system being responsive to outputs from detector apparatus associated with others of the computers. The system may be arranged to monitor changes in the outputs of different detectors and to determine movement of a detected substance.

According to a further aspect of the present invention there is provided a method of detection including providing a plurality of computers, connecting chemical detection apparatus with each computer, and receiving at a remote location information from the plurality of computers.

A system including several detection arrangements will now be described, by way of example, with reference to the accompanying drawing, in which:

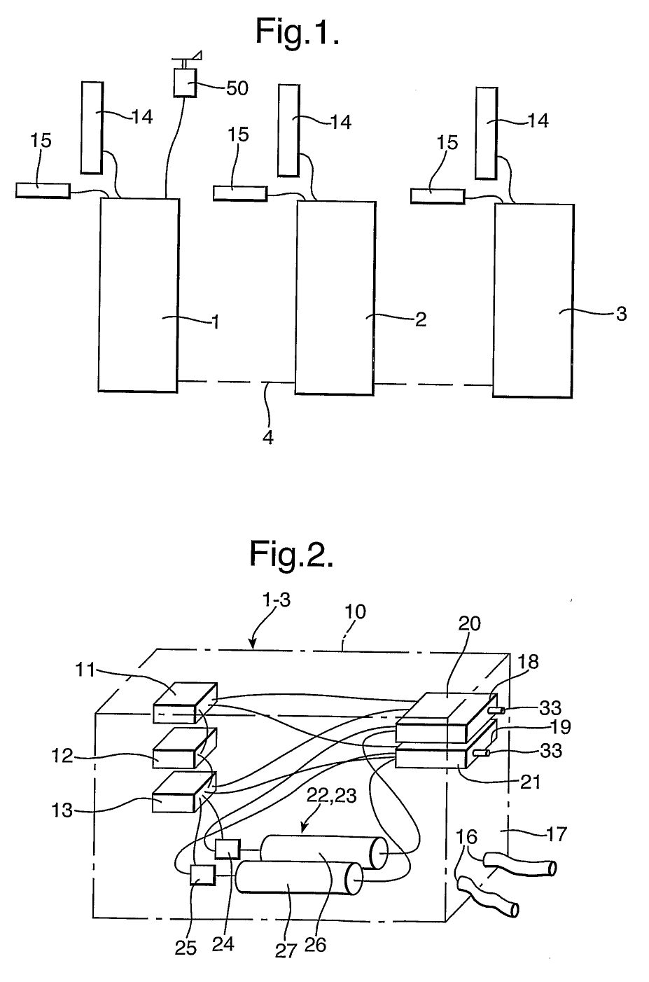

FIG. 1 shows the system schematically;

FIG. 2 is a cut-away, perspective, schematic view of the detection arrangement;

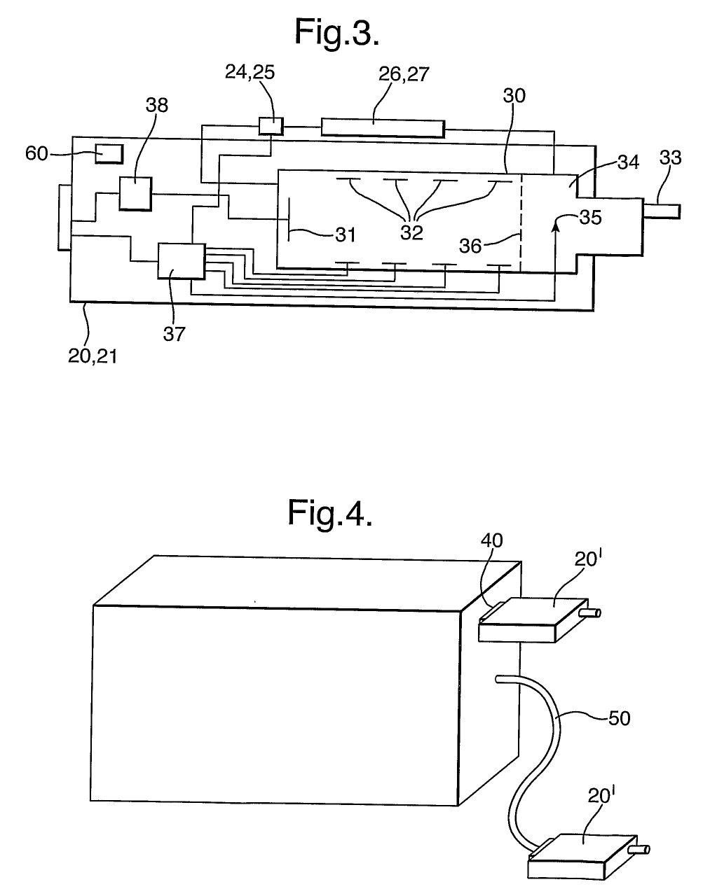

FIG. 3 is a schematic cross-sectional side elevation view of an IMS detector used in the detection arrangement; and

FIG. 4 is a perspective view of two alternative detection arrangements.

With reference first to FIGS. 1 to 3, the system comprises two or more computers and, in the present example, includes three computers 1 to 3 interconnected with one another such as via an intranet or internet arrangement, illustrated by the cable 4. It will be appreciated that the interconnection need not be via an electrical cable but could be by a fibre-optic cable or by a cableless arrangement, such as involving radio or infrared signals. Each of the computers 1 to 3 is of the personal computer PC kind including a housing 10 containing the processors 11, memory 12, power supplies 13 and other functions. The computers 1 to 3 also each include a display 14 and a keyboard 15. Different kinds of computers could be used, such as laptops, PDA, servers. The system could include a mixture of several different kinds of computer. The computers are not dedicated to a detection function but are arranged normally to provide other functions such as word processing, database management or the like unrelated to the detection function. The computers could be those of the kind used to monitor industrial processes, air conditioning, fire alarm or intruder alarm systems.

In the present example, the housing 10 is a box-like structure with various input and output sockets 16 on its rear vertical face 17, including two rectangular PCI slots 18 and 19 for receiving spare cards, drives or the like. Two chemical detector apparatus in the form of ion mobility spectrometers 20 and 21 (such as the LCD detector available from Smiths Detection-Watford Limited in the UK) are fitted into respective ones of these slots 18 and 19 so that the gas inlet end face of the detectors is exposed on the outside of the housing flush with the face 17. It will be appreciated that different numbers of detectors could be used according to the range of chemicals needed to be detected. Each IMS apparatus 20 and 21 is modified by having external pneumatic circuits 22 and 23 in place of the conventional pneumatics within the housing of the IMS. Each of the external pneumatic circuits includes a pump 24 and 25 and one or more sieve packs 26 and 27. The sieve packs 26 and 27 can be relatively large, that is, larger than the IMS housing. This prolongs the operational life of the sieve packs up to about 12 months so that the MS can be operated unattended for this period. The two IMS 20 and 21 preferably operate with different dopant chemistries, such as ammonia and acetone, so that they are responsive to different chemicals.

Within each IMS apparatus 20 and 21 there is a conventional IMS drift tube 30, with a collector plate 31 at its left-hand end and drift electrodes 32 spaced from one another along the length of the tube. A gas sampling inlet 33 at the right-hand end of the tube 30 opens into an ionization region 34 including a corona discharge point 35. The inlet 33 projects outwardly a short distance beyond the rear face 17 of the computer housing 10. The ionization region 34 is separated from the right-hand end of the drift tube 30 by a conventional electronic shutter arrangement 36. Gas is circulated through the tube 30 from left to right, against the ion flow, by the external pump 24 or 25 and via the respective sieve pack 26 or 27. Power to drive the corona 35, the drift electrodes 32, the shutter 36 and the pumps 24 and 25 is obtained via electrical connection to the power supply 13 in the computer. The IMS apparatus 20 and 21 each include a power supply unit 37 by which the power from the computer is regulated to a form suitable for the different requirements of the corona 35, electrodes 32, shutter 36 and pump 24 or 25.

The processing for the IMS apparatus 20 and 21 may be carried out by processors 38 within the IMS units or the major part of the processing could be carried out in the computer 1, 2, 3. In particular, the computer 1, 2, 3 could be arranged to process the output from the collector plate 31 to produce spectra representative of the time of flight of the different ion species supplied to the drift tube 30. It compares this with spectra of known substances and provides an output indicative of the nature of the substance. This output may be displayed on the monitor 14 of the computer 1, 2 or 3 at which the detectors 20 and 21 are located and is preferably stored in case the computer is unattended. When a hazardous substance is detected, the computer 1, 2, 3 is preferably arranged to provide an audible alarm warning as well as a visual indication, the alarm warning could include a synthesised voice warning people in the vicinity of the computer to move away from the area.

In the present system, each computer 1, 2, 3 is programmed to provide information via the intranet 4 to other computers in the system about any abnormal substance detected in the air. In this way, each computer is provided with information about potential hazards in the vicinity of any of the computers. One or more of the computers may be arranged to track changes in the outputs of the different detectors and, from knowledge of each detector's location, predict movement of the hazardous substance. In this respect, one or more of the computers may be arranged to receive meteorological information, in particular, wind speed and direction. This information may be obtained from dedicated meteorological sensors 50 or it may be obtained from, for example, a local weather station with an internet output. Alternatively, where no sensors are available, estimates could be provided from knowledge of typical local conditions, or the user could be prompted to enter this information manually.

Each detector could include a GPS sensor 60 to provide exact information to the computer system about the location of the detector. Alternatively, the GPS sensor could be provided outside the detector housing and connected to the computer such as via a further USB port.

It is not essential that the detector apparatus be contained within the housing of the computer. Instead, as shown in FIG. 4, a detector 20′ could be supported by a plug 40, such as a USB port, on the outside of the computer housing or it could be connected to a port on the computer via a cable 50. This latter arrangement might have the advantage of enabling the detector to be located in a position where it is more likely to be exposed to hazardous substances. For example, it could be located outside or in a ventilation duct and connected to the computer via a cable.

Each detector 20, 21 would normally be provided with programming information, such as on a separate CD-ROM disc. When the detector 20, 21 is installed in the computer, the computer would prompt the user to load the disc so that the detector programming information on the disc is downloaded into the computer. Alternatively, the programming could be achieved by connecting to a computer at a remote site, such as via an internet connection, and the programming information downloaded from that site.

Instead of having two detectors and external pneumatic circuits, it would be possible to have a single detector, mounted in the upper slot and a unit containing the pneumatic circuit for the detector mounted in the lower disk drive slot. This would have the advantage that the system could be built into any PC with two empty slots and without the need for the additional pneumatics. The sieve pack could be changed by opening a drawer in a slot from outside the computer. The computer would preferably be loaded with software to monitor operation of the detector and provide a notification to the operator, or remotely, when the sieve is close to exhaustion and needs to be replaced. The detector, in effect becomes a computer peripheral, just like a disk drive, which can easily be installed and then operated by running the special software.

The invention is not confined to ion mobility spectrometers but could be used with other forms of detector apparatus including those for detecting biological substances.

The present invention could enable the detectors to be rapidly updated or changed. For example, the detectors might be installed in computers in several different military bases. If intelligence is obtained that there is a likely threat from a chemical different from those for which the detector apparatus are programmed, information about the characteristic spectra of that chemical would be transmitted, such as via the military intranet to all the military bases. In this way, each detector apparatus could automatically be programmed with the new spectra very quickly and with little or no local intervention.

The present invention, enables detectors to be installed inconspicuously and, by making use of some of the functions available within a computer, at reduced cost. The detectors can be installed in multiple locations and operate unattended for prolonged periods. Warning information can be distributed without the need for special cabling since it makes use of existing intranet systems.

1. A detection arrangement, wherein the arrangement includes a computer, chemical detector apparatus and an electrical interconnection of the detector apparatus with the computer, and that the computer is arranged to provide a source of electrical power for the detector apparatus and is arranged to receive an output from the detector apparatus.

2. A detection arrangement according to claim 1, wherein the detector apparatus is located within the housing of the computer.

3. A detection arrangement according to claim 1, wherein the computer includes two separate detector apparatus responsive to different chemicals.

4. A detection arrangement according to claim 3, wherein the two separate detector apparatus have different doping.

5. A detection arrangement according to claim 1, wherein the or each detector apparatus includes an ion mobility spectrometer.

6. A detection arrangement according to claim 5, wherein the or each ion mobility spectrometer includes a sieve pack located outside the spectrometer but within the housing of the computer with which the spectrometer is associated.

7. A detection arrangement according to claim 1, wherein the or each detector apparatus is located in a PCI slot of the computer.

8. A detection arrangement according to claim 1, wherein the computer provides at least a part of the processing for the or each detector apparatus.

9. A detection arrangement according to claim 1, wherein detection of a substance is indicated by an output indication by the computer associated with the detector apparatus.

10. A detection arrangement according to claim 9, wherein the output indication includes an audible indication.

11. A detection arrangement according to claim 1, wherein the arrangement includes a meteorological information input.

12. A detection arrangement according to claim 1, wherein the computer includes a position input.

13. A system including a plurality of detection arrangements according to claim 1.

14. A system according to claim 13, wherein the computers of the detection arrangements are interconnected with one another, and that at least one computer in the system is responsive to outputs from detector apparatus associated with others of the computers.

15. A system according to claim 13, wherein the system is arranged to monitor changes in the outputs of different detectors and to determine movement of a detected substance.

16. A method of detection including providing a plurality of computers, connecting chemical detection apparatus with each computer, and receiving at a remote location information from the plurality of computers.
